(19) United States
(12) Patent Application Publication
(10) Pub. No.: US 2024/0226770 A1
(43) Pub. Date: Jul. 11, 2024

(54) DISTILLATION PROCESS WITH A LAVAL NOZZLE

(71) Applicant: BASF SE, Ludwigshafen am Rhein (DE)

(72) Inventors: Bernd METZEN, Ludwigshafen am Rhein (DE); Torsten MATTKE, Ludwigshafen am Rhein (DE)

(21) Appl. No.: 18/561,836

(22) PCT Filed: May 16, 2022
(86) PCT No.: PCT/EP2022/063128

§ 371 Date: Nov. 17, 2023

(30) Foreign Application Priority Data
May 26, 2021 (EP) 21176002.0

(51) Int. Cl. B01D 5/00; B01D 3/14

(52) U.S. Cl. CPC B01D 5/0063; B01D 3/14

(57) ABSTRACT

The invention relates to a process for at least partially separating a light boiling component from a mixture containing said light boiling component and at least a heavy boiling component, the process comprising the steps of (a) feeding the mixture into a distillation column and withdrawing a distillate stream enriched in the light boiling component from the top section of the distillation column and withdrawing a bottom stream enriched in the heavy boiling component from the bottom section of the distillation column: and (b) transferring at least part of the distillate stream as a condensation stream to a condensation device wherein the condensation stream is at least partially condensed and recycled to the top section of the distillation column, wherein the condensation device comprises a pump and a de Laval nozzle having a throat, a converging zone before the throat and a diverging zone after the throat, the condensation stream being passed into the converging zone of the de Laval nozzle, the condensation stream being accelerated to sonic speed while passing the throat, the condensation stream being expanded in the diverging zone to supersonic speed, thereby at least part of the condensation stream being condensed to form a liquid recycle stream, and the recycle stream being recycled through the pump to the top section of the distillation column.

The present invention relates to a process for at least partially separating a light boiling component from a mixture containing said light boiling component and at least a heavy boiling component, the process comprising the steps of (a) feeding the mixture into a distillation column and withdrawing a distillate stream enriched in the light boiling component from the top section of the distillation column and withdrawing a bottom stream enriched in the heavy boiling component from the bottom section of the distillation column; and (b) transferring at least part of the distillate stream as a condensation stream to a condensation device wherein the condensation stream is at least partially condensed and recycled to the top section of the distillation column.

Distillation is one of the most widespread thermal separation methods in the chemical industry. The principle for separating components from a mixture is based on different boiling points of the components. Distillation is carried out in columns, in which a vapor phase and a liquid phase flow in countercurrent flows. Internals like trays or packings are provided in the column which provoke mass and heat exchange between the phases, so that the lighter boiling components enrich in the vapor phase and are entrained by the vapor flow to the top of the column, whereas the heavier boiling components enrich in the liquid phase and are entrained by the liquid flow to the bottom of the column.

The flow of liquid from the top of the column down to its bottom is often realized by at least partially condensing the vapor flow leaving the top of the column in a so-called “reflux condenser” and returning at least part of the condensed vapor to the top of the column. The flow of vapor from the bottom of the column up to its top is often realized by at least partially vaporizing the liquid flow leaving the bottom of the column in a so-called “reboiler” and returning the vapor flow to the bottom of the column.

Condensing the vapor flow from the top of the column and vaporizing the liquid flow from the bottom of the column necessitate energy which represents the major part of the operating costs of a distillation column. Thus, many strategies to reduce the operating costs have been developed in the art. Concerning the condensation, the main strategy is to use a heat exchange medium which is cooler than the vapor. For vapor flows with a dew point temperature of more than 30° C. air or water are typically used for this purpose. As a certain temperature difference is necessary for the heat exchange, for vapor flows with a dew point temperature of less than about 30° C., it is necessary to use more expensive heat exchange media, e.g. chilled water or other refrigerated media.

It was an object of the invention to provide a distillation process with a reduced energy demand, particularly a reduced energy demand needed for the condensation of vapor flows at the top of the distillation column.

This object is achieved according to the invention by a separation process according to claim 1. Advantageous embodiments and further developments of the process are presented in the dependent claims 2 to 7.

A first subject of the invention is a process for at least partially separating a light boiling component from a mixture containing said light boiling component and at least a heavy boiling component, the process comprising the steps of
a) feeding the mixture into a distillation column and withdrawing a distillate stream enriched in the light boiling component from the top section of the distillation column and withdrawing a bottom stream enriched in the heavy boiling component from the bottom section of the distillation column; and
b) transferring at least part of the distillate stream as a condensation stream to a condensation device wherein the condensation stream is at least partially condensed and recycled to the top section of the distillation column.

According to the invention the condensation device comprises a pump and a de Laval nozzle having a throat, a converging zone before the throat and a diverging zone after the throat, the condensation stream being passed into the converging zone of the de Laval nozzle, the condensation stream being accelerated to sonic speed while passing the throat, the condensation stream being expanded in the diverging zone to supersonic speed, thereby at least part of the condensation stream being condensed to form a liquid recycle stream, and the recycle stream being recycled through the pump to the top section of the distillation column.

A de Laval nozzle, also named convergent-divergent nozzle, is a tube that is pinched in the middle, making an asymmetric hourglass shape. The section with the smallest diameter of this hourglass shape is also called “the throat”. The section between the inlet of the nozzle and the throat is the so-called “converging zone”. The section between the throat and the outlet of the nozzle is called “diverging zone”. A de Laval nozzle is used to accelerate a pressurized gas at subsonic speed to a supersonic speed by passing through the nozzle in the axial direction, thereby converting the heat energy of the gas into kinetic energy. Because of this effect, de Laval nozzles are widely used in some types of steam turbines, rocket engine nozzles and in some supersonic jet engines.

De Laval nozzles are also used as separators in process industry, for example for the separation or drying of natural gas. The documents EP 1 140 363 B1 and US 2018/0369711 A1 give examples of such applications. A further example is disclosed in the document U.S. Pat. No. 10,436,506 B2. There, a de Laval nozzle is used for the separation of C2 to C4 hydrocarbons making use of the effect of partial condensation of the hydrocarbon mixture.

So far, it is not known in the art to use a de Laval nozzle as an integrated part of a distillation process. It has been found that using a de Laval nozzle as a reflux condenser of a distillation column according to the invention significantly reduces the energy demand needed for the condensation of vapor flows at the top of the distillation column.

The diverging zone may have any suitable shape known in the art, e.g. cone-shape or bell-shape. Methods to design a de Laval nozzle based on given operating conditions are known in the art.

In a preferred embodiment of the inventive process the liquid recycle stream is removed from the diverging zone upstream to the outlet of the de Laval nozzle.

It is further preferred that the pressure conditions before and after the de Laval nozzle are chosen to create a pressure shock inside the diverging zone downstream of the point of removal of the recycle stream. The position of the pressure shock has an influence on the separation efficiency of the de Laval nozzle and can be chosen according to the operational needs. In an advantageous variant of this embodiment the pressure conditions upstream and/or downstream the de Laval nozzle are adapted for changing operating conditions in order to fix the position of the shock wave at a predetermined position. Preferably, the adaptation is done by a controller that influences the gas flow through the nozzle, for example by throttling the gas flow upstream and/or downstream of the de Laval nozzle.

In a preferred embodiment of the inventive process the condensation stream is passed through a pressure-reducing device before entering the converging zone of the de Laval nozzle. In this embodiment the top pressure of the distillation column is decoupled from the condensation pressure. This is advantageous as it gives a degree of freedom for operating the distillation process.

In another preferred embodiment the condensation stream leaving the de Laval nozzle is passed through a pressure-reducing device. In this embodiment, the position of the pressure shock can be influenced in an easy and efficient manner.

It is further preferred that the condensation stream is passed through a pressure-reducing device before entering the converging zone of the de Laval nozzle, and the condensation stream leaving the de Laval nozzle is passed through a pressure-reducing device. In this embodiment, the process can be easily adapted to varying feed or recycle conditions.

In a further preferred embodiment the condensation stream is passed through a condenser where at least part of the condensation stream is condensed to form a first liquid recycle stream before the non-condensed part of the condensation stream enters the converging zone of the de Laval nozzle. By providing an additional condenser in series with the de Laval nozzle the operational range for condensing the vapor flow from the top of the distillation column is enlarged. The provision of an additional condenser may also facilitate the start-up and shut down of the distillation column.

In a further preferred embodiment the condensation stream is split up to form at least a first condensation stream and a second condensation stream, the first condensation stream being passed through a condenser where at least part of the condensation stream is condensed to form a first liquid recycle stream, and the second condensation stream being passed into the converging zone of the de Laval nozzle. By providing an additional condenser in parallel to the de Laval nozzle the operational range for condensing the vapor flow from the top of the distillation column is enlarged. The provision of an additional condenser may also facilitate the start-up and shut down of the distillation column. For example, the additional condenser may be operated during start-up of the plant until the operating point of the de Laval nozzle has been reached. Thereafter, the additional condenser may be kept in operation or may be shut down, depending on the operational needs.

In a further preferred embodiment the condensation device comprises at least two de Laval nozzles, the condensation stream being split up, the split-up condensation streams being passed into the corresponding converging zones of the de Laval nozzles, the partial condensation streams being accelerated to sonic speed while passing the throats, the partial condensation streams being expanded in the diverging zones to supersonic speed, thereby at least part of the partial condensation streams being condensed to form liquid recycle streams, and the recycle streams being recycled through the pump to the top section of the distillation column. By providing at least two de Laval nozzles in parallel the operational range for condensing the vapor flow from the top of the distillation column is enlarged. The provision of at least two de Laval nozzles may also facilitate the start-up and shut down of the distillation column.

The at least two de Laval nozzles may be of identical design and condensation capacity or of different design or condensation capacity.

In an embodiment with two de Laval nozzles, both nozzles may have a capacity from 40 to 60%, preferably from 45 to 55% of the total condensation capacity needed.

In an embodiment with three de Laval nozzles, the first nozzle may have a capacity from 40 to 60%, preferably from 45 to 55% of the total condensation capacity needed, and the second and third nozzles may each have a capacity from 20 to 30% of the total condensation capacity needed.

In an embodiment with four de Laval nozzles, the first nozzle may have a capacity from 40 to 60%, preferably from 45 to 55% of the total condensation capacity needed, the second nozzle may have a capacity from 20 to 30% of the total condensation capacity needed, and the third and fourth nozzles may each have a capacity from 10 to 15% of the total condensation capacity needed.

The condensation device may comprise several condensers and de Laval nozzles that are connected in series and/or in parallel, depending on the condensation task to be solved for a distillation process.

It is further preferred that the condensation stream is swirled before being passed into the converging zone of the de Laval nozzle. This improves the separation efficiency as the centrifugal forces ensure that the condensate is separated at the nozzle wall where it can be removed.

Compared to the classical indirect vapor condensation by heat extraction, investment costs and energy demand can be drastically reduced by the inventive process, especially if a refrigeration plant can be avoided. Thus, the inventive process is especially suited for separation tasks with low condensation temperatures. The only investment needed is a de Laval nozzle and a pump to return the condensate to the column. In the Laval nozzle, the condensation energy is removed by the remaining, non-condensed vapor. This vapor is heated up accordingly. Energy costs are only incurred by the pump and are orders of magnitude smaller than in the conventional system with a refrigeration plant.

### COMPARATIVE EXAMPLE

A stream of 30 tons/hour of gaseous hydrogen chloride is fed to a distillation column at a temperature of 4° C. The feed stream contains 0.09 wt.-% of monochlorobenzene, which is the heavy boiling component and is withdrawn from the bottom of the distillation column. The pressure at the top of the distillation column is 13.75 bar abs. A distillate stream of nearly pure hydrogen chloride is withdrawn from the distillation column and is transferred to a condenser. In the condenser the distillate stream is cooled down to a temperature of about −22° C., thereby condensing a part of the vapor. The condensed liquid is recycled to the top of the distillation column as the reflux stream. The heat exchange medium is monochlorobenzene that is cooled down to a temperature of −35° C. in a refrigeration plant. The condensation process requires an electrical energy of 58 kWh/h and an amount of the heat exchange medium of approximately 60 m³/h.

### Example According to the Invention

The same distillation column as in the comparative example is used to separate monochlorobenzene from hydrogen chloride. The only difference is that the condenser and the refrigeration plant are substituted by a de Laval nozzle and a pump for transferring the condensed liquid back to the top of the distillation column.

The distillate stream of nearly pure hydrogen chloride is withdrawn from the distillation column and is passed into the converging zone of the de Laval nozzle. The stream is accelerated to sonic speed while passing the throat and is expanded in the diverging zone to supersonic speed. The pressure after expansion is 6.1 bar abs and the temperature −46° C. As a result, a part of the stream condenses. The condensed liquid is withdrawn from the nozzle and is recycled to the top of the distillation column via the pump. The energy needed for the pump is about 1 kWh/h. Apparently, the energy demand for the inventive process is significantly lower than for the conventional process.

The non-condensed vapor stream undergoes a pressure shock inside the diverging zone downstream of the point of removal of the recycle stream. Its velocity is thereby reduced to subsonic speed and its pressure rises to approximately 13 bar abs. Thus, a large part of the kinetic energy is transformed back into pressure. The temperature of the compressed vapor at the outlet of the diffusor is about 8° C.

1.-7. (canceled)

8. A process for at least partially separating a light boiling component from a mixture containing said light boiling component and at least a heavy boiling component comprising the steps of
a) feeding the mixture into a distillation column and withdrawing a distillate stream enriched in the light boiling component from the top section of the distillation column and withdrawing a bottom stream enriched in the heavy boiling component from the bottom section of the distillation column; and
b) transferring at least part of the distillate stream as a condensation stream to a condensation device wherein the condensation stream is at least partially condensed and recycled to the top section of the distillation column;
wherein the condensation device comprises a pump and a de Laval nozzle having a throat, a converging zone before the throat and a diverging zone after the throat, the condensation stream being passed into the converging zone of the de Laval nozzle, the condensation stream being accelerated to sonic speed while passing the throat, the condensation stream being expanded in the diverging zone to supersonic speed, thereby at least part of the condensation stream being condensed to form a liquid recycle stream, characterized in that the recycle stream is recycled through the pump to the top section of the distillation column.

9. The process according to claim 8, wherein the condensation stream is passed through a pressure-reducing device before entering the converging zone of the de Laval nozzle.

10. The process according to claim 8, wherein the condensation stream leaving the de Laval nozzle is passed through a pressure-reducing device.

11. The process according to claim 8, wherein the condensation stream is passed through a condenser where at least part of the condensation stream is condensed to form a first liquid recycle stream before the non-condensed part of the condensation stream enters the converging zone of the de Laval nozzle.

12. The process according to claim 8, wherein the condensation stream is split up to form at least a first condensation stream and a second condensation stream, the first condensation stream being passed through a condenser where at least part of the condensation stream is condensed to form a first liquid recycle stream, and the second condensation stream being passed into the converging zone of the de Laval nozzle.

13. The process according to claim 8, the condensation device comprises at least two de Laval nozzles, the condensation stream being split up, the split-up condensation streams being passed into the corresponding converging zones of the de Laval nozzles, the partial condensation streams being accelerated to sonic speed while passing the throats, the partial condensation streams being expanded in the diverging zones to supersonic speed, thereby at least part of the partial condensation streams being condensed to form liquid recycle streams, and the recycle streams being recycled through the pump to the top section of the distillation column.

14. The process according to claim 8, wherein the condensation stream is swirled before being passed into the converging zone of the de Laval nozzle.
